(19) United States
(12) Patent Application Publication
(10) Pub. No.: US 2018/0034812 A1
(43) Pub. Date: Feb. 1, 2018

(54) SYSTEMS AND METHODS OF ILLUMINATION CONTROL FOR BIOMETRIC CAPTURE AND LIVENESS DETECTION

(71) Applicant: EYELOCK LLC, New York, NY (US)

(72) Inventor: A. K. M. Mahbubur Rahman, Lawrenceville, NJ (US)

(73) Assignee: EYELOCK LLC, New York, NY (US)

(21) Appl. No.: 15/657,479

(22) Filed: Jul. 24, 2017

Related U.S. Application Data
(60) Provisional application No. 62/366,766, filed on Jul. 26, 2016.

(51) Int. Cl. H04L 29/06; G06F 21/32; G06K 9/00

(52) U.S. Cl. CPC H04L 63/0861; G06K 9/00906; G06F 21/32; G06K 9/2027

(57) ABSTRACT

The present disclosure describes illumination control for biometric capture with liveness detection. A first near infra-red (NIR) illuminator illuminates, during a first time slice, a right eye and/or a left eye, and may be located within a predetermined distance from a sensor. A second NIR illuminator may illuminate, during a second time slice, the right eye and/or left eye. The second NIR illuminator may be located at a second distance larger than the predetermined distance. A third NIR illuminator may illuminate, during a third time slice, the right eye and/or left eye, and may be located at a third distance that is larger than the predetermined distance. The sensor may be used to detect a red-eye effect during the first time slice, and capture an image of the right eye and/or left eye during the second time slice, and a second image during the third time slice.

### CROSS REFERENCE TO RELATED APPLICATIONS

This application claims the benefit of and priority to U.S. Provisional Application Ser. No. 62/366,766, filed Jul. 26, 2016, entitled “SYSTEMS AND METHODS OF ILLUMINATION CONTROL FOR BIOMETRIC CAPTURE AND LIVENESS DETECTION”. The entire content of the foregoing is incorporated herein by reference for all purposes.

### FIELD OF THE DISCLOSURE

This disclosure generally relates to systems and methods for configuring illumination for biometric purposes, including but not limited to systems and methods of illumination control for biometric capture with liveness detection.

### BACKGROUND OF THE DISCLOSURE

Iris recognition is one of the most accurate and widely popular methods in biometric authentication. It is a contactless method that uses digital images of the detail-rich iris texture to create a genuine discrete biometric signature for the authentication. The images may be acquired by near infrared (NIR) light illumination of human eyes. Spoofing of iris biometric data can compromise an authentication system that relies on the iris biometric data to verify an identify. Therefore, an effective and non-intrusive means of using liveness detection in conjunction with acquisition of iris biometric data can be helpful to mitigate risks arising from spoofing.

### SUMMARY OF THE DISCLOSURE

Described herein are systems and methods of illumination control for biometric capture and liveness detection. Liveness detection can be performed in conjunction with biometric capture to ensure that liveness can be attributed to the individual whose iris biometrics are being captured. By integrating and interoperating the liveness detection and biometric capturing mechanisms within a single device, both functions can be performed effectively and efficiently. In some embodiments, the device (which can be a smart phone, laptop computer, tablet, etc.) uses a number of illuminators that interoperate with an imaging sensor to perform liveness detection and biometric capturing. At least one of the illuminators is positioned relative to the imaging sensor to cause a red-eye effect on a live eye, to confirm liveness of the eye from which iris biometrics may be acquired using one or more other illuminators on the same device.

In one aspect, this disclosure is directed to a method for iris illumination. The method may include illuminating, by a first near infra-red (NIR) illuminator during a first time slice, at least one of a right eye or a left eye of a user. The first NIR illuminator may be located within a predetermined distance from an imaging sensor on a computing device. A second NIR illuminator may illuminate, during a second time slice different from the first time slice, at least one of the right eye or the left eye. The second NIR illuminator may be located from the imaging sensor at a second distance that is larger than the predetermined distance. A third NIR illuminator may illuminate, during a third time slice different from the first and second time slices, at least one of the right eye or the left eye. The third NIR illuminator may be located from the imaging sensor at a third distance that is larger than the predetermined distance. The imaging sensor may be used to detect a red-eye effect in at least one of the right eye or the left eye during the first time slice. The imaging sensor may capture a first image of at least one of the right eye or the left eye during the second time slice, and a second image of at least one of the right eye or the left eye during the third time slice.

In some embodiments, the imaging sensor captures, responsive to the detection of the red-eye effect using the imaging sensor, the first image during the second time slice and the second image during the third time slice. The first NIR illuminator may illuminate at least one of the right eye or the left eye at a first illumination level that is different from that of the second and third NIR illuminators during the second and third time slices. The first time slice extends over a duration that is different from that of the second and third time slices. The predetermined distance, the second distance and the third distance from the imaging sensor may comprise a predetermined angular distance, a second angular distance and a third angular distance respectively, between a respective illuminator's illumination axis and an imaging axis of the imaging sensor.

In some embodiments, the predetermined distance comprises a spatial distance or angular distance within which a NIR light source causes red-eye effect, and beyond which the NIR light source does not cause red-eye effect. The first, second and third time slices may all occur within a predetermined time period. The first, second and third time slices may all occur within a time period of 25 milliseconds. The red-eye effect may comprise an internal reflection of light entering a pupil. In certain embodiments, the method may include storing or using at least one of the first image or the second image for biometric matching, responsive to detecting the red-eye effect.

In another aspect, this disclosure is directed to a system for iris illumination. The system may include an imaging sensor. The system may include a first near infra-red (NIR) illuminator configured to illuminate at least one of a right eye or a left eye of a user during a first time slice. The first NIR illuminator may be located within a predetermined distance from an imaging sensor on a computing device. A second NIR illuminator may be configured to illuminate at least one of the right eye or the left eye during a second time slice different from the first time slice. The second NIR illuminator may be located from the imaging sensor at a second distance that is larger than the predetermined distance. A third NIR illuminator may be configured to illuminate at least one of the right eye or the left eye during a third time slice different from the first and second time slices. The third NIR illuminator may be located from the imaging sensor at a third distance that is larger than the predetermined distance. The imaging sensor is used to detect a red-eye effect in at least one of the right eye or the left eye during the first time slice. The imaging sensor may be configured to capture a first image of at least one of the right eye or the left eye during the second time slice and a second image of at least one of the right eye or the left eye during the third time slice.

In some embodiments, the imaging sensor is configured to capture, responsive to the detection of the red-eye effect, the first image during the second time slice and the second image during the third time slice. The first NIR illuminator is configured to illuminate at least one of the right eye or the left eye at a first illumination level that is different from that of the second and third NIR illuminators during the second and third time slices. The first time slice may extend over a duration that is different from that of the second and third time slices. The predetermined distance, the second distance and the third distance from the imaging sensor may comprise a predetermined angular distance, a second angular distance and a third angular distance respectively, between a respective illuminator's illumination axis and an imaging axis of the imaging sensor.

The predetermined distance may comprise a spatial distance or angular distance within which a NIR light source causes red-eye effect, and beyond which the NIR light source does not cause red-eye effect. The first, second and third time slices may all occur within a predetermined time period. The first, second and third time slices may all occur within a time period of 25 milliseconds. The red-eye effect may comprise an internal reflection of light entering a pupil. A processor of the system may be configured to store or use at least one of the first image or the second image for biometric matching, responsive to detecting the red-eye effect.

The details of various embodiments of the invention are set forth in the accompanying drawings and the description below.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIGS. 1B and 1C are block diagrams depicting embodiments of computing devices useful in connection with the methods and systems described herein;

FIG. 2A is a block diagram depicting one embodiment of a system of illumination control for biometric capture and liveness detection;

FIG. 2B is a diagram depicting an example embodiment of a system of illumination control for biometric capture and liveness detection; and

FIG. 2C is a flow diagram depicting one embodiment of a method of illumination control for biometric capture and liveness detection.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein; and

Section B describes embodiments of systems and methods of illumination control for biometric capture and liveness detection.

### A. Computing and Network Environment

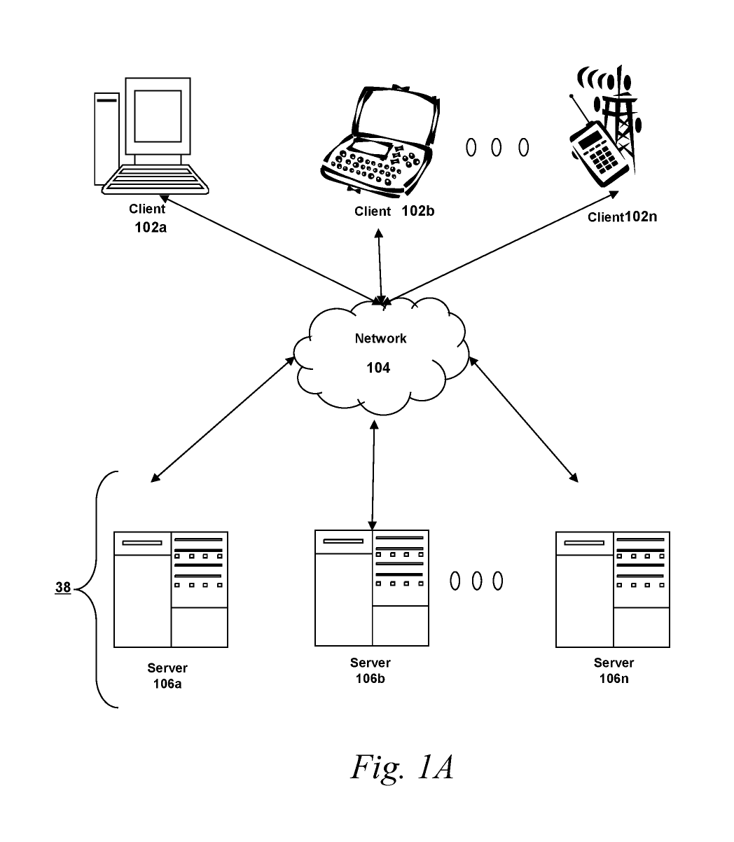

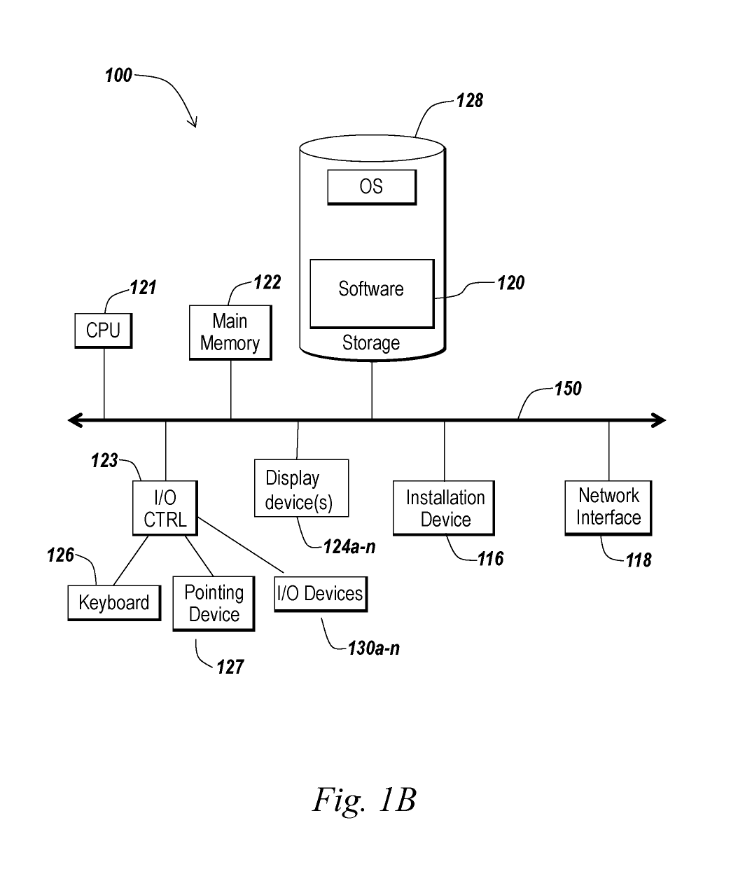

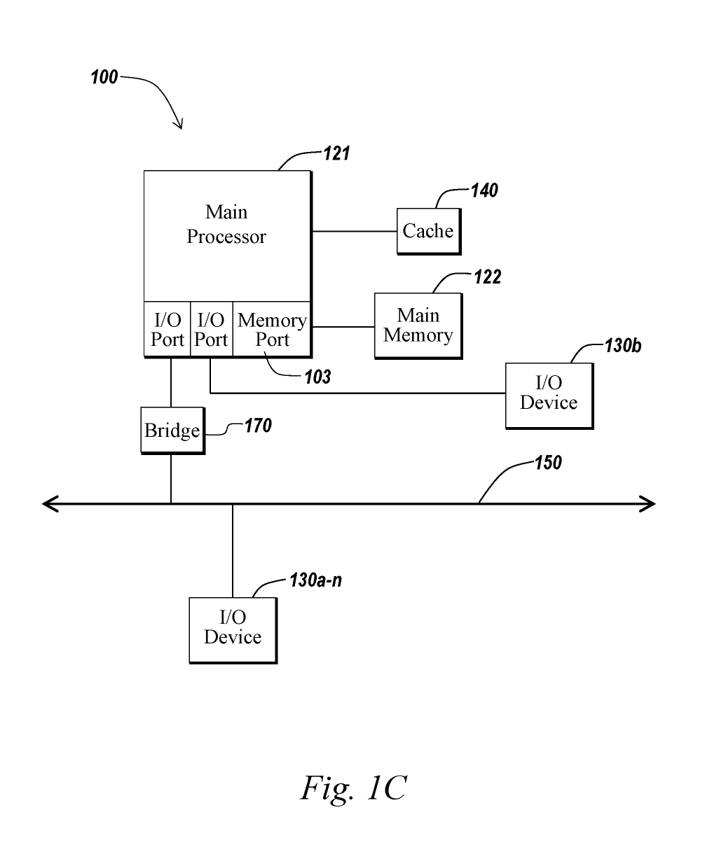

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 101a-101n (also generally referred to as local machine(s) 101, client(s) 101, client node(s) 101, client machine(s) 101, client computer(s) 101, client device(s) 101, endpoint(s) 101, or endpoint node(s) 101) in communication with one or more servers 106a-106n (also generally referred to as server(s) 106, node 106, or remote machine(s) 106) via one or more networks 104. In some embodiments, a client 101 has the capacity to function as both a client node seeking access to resources provided by a server and as a server providing access to hosted resources for other clients 101a-101n.

Although FIG. 1A shows a network 104 between the clients 101 and the servers 106, the clients 101 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 101 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol(s) or standard(s) used to communicate among mobile devices, including AMPS, TDMA, CDMA, GSM, GPRS, UMTS, WiMAX, 3G or 4G. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the Virtual Server or virtual PC hypervisors provided by Microsoft or others.

In order to manage a machine farm 38, at least one aspect of the performance of servers 106 in the machine farm 38 should be monitored. Typically, the load placed on each server 106 or the status of sessions running on each server 106 is monitored. In some embodiments, a centralized service may provide management for machine farm 38. The centralized service may gather and store information about a plurality of servers 106, respond to requests for access to resources hosted by servers 106, and enable the establishment of connections between client machines 101 and servers 106.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In one embodiment, the server 106 provides the functionality of a web server. In another embodiment, the server 106a receives requests from the client 101, forwards the requests to a second server 106b and responds to the request by the client 101 with a response to the request from the server 106b. In still another embodiment, the server 106 acquires an enumeration of applications available to the client 101 and address information associated with a server 106′ hosting an application identified by the enumeration of applications. In yet another embodiment, the server 106 presents the response to the request to the client 101 using a web interface. In one embodiment, the client 101 communicates directly with the server 106 to access the identified application. In another embodiment, the client 101 receives output data, such as display data, generated by an execution of the identified application on the server 106.

The client 101 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 101 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-101n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive or any other device suitable for installing software and programs. The computing device 100 can further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium, for example, a bootable CD.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 123a-123n. In one embodiment, a video adapter may comprise multiple connectors to interface to multiple display devices 123a-123n. In other embodiments, the computing device 100 may include multiple video adapters, with each video adapter connected to one or more of the display devices 123a-123n. In some embodiments, any portion of the operating system of the computing device 100 may be configured for using multiple displays 123a-123n. In other embodiments, one or more of the display devices 123a-123n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 123a-123n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, manufactured by Google Inc; WINDOWS 7 and 8, manufactured by Microsoft Corporation of Redmond, Wash.; MAC OS, manufactured by Apple Computer of Cupertino, Calif.; WebOS, manufactured by Research In Motion (RIM); OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPAD or IPOD family of devices manufactured by Apple Computer of Cupertino, Calif., a device of the PLAYSTATION family of devices manufactured by the Sony Corporation of Tokyo, Japan, a device of the NINTENDO/Wii family of devices manufactured by Nintendo Co., Ltd., of Kyoto, Japan, or an XBOX device manufactured by the Microsoft Corporation of Redmond, Wash.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry handheld or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a tablet such as the Apple IPAD, or a digital audio player such as the Apple IPOD lines of devices, manufactured by Apple Computer of Cupertino, Calif. In another of these embodiments, the digital audio player may function as both a portable media player and as a mass storage device. In other embodiments, the computing device 100 is a digital audio player such as an MP3 player. In yet other embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the communications device 101 includes a combination of devices, such as a mobile phone combined with a digital audio player or portable media player. In one of these embodiments, the communications device 101 is a smartphone, for example, an iPhone manufactured by Apple Computer, or a Blackberry device, manufactured by Research In Motion Limited. In yet another embodiment, the communications device 101 is a laptop or desktop computer equipped with a web browser and a microphone and speaker system, such as a telephony headset. In these embodiments, the communications devices 101 are web-enabled and can receive and initiate phone calls.

### B. Illumination Control for Biometric Capture and Liveness Detection

Described herein are systems and methods of illumination control for biometric capture and liveness detection. In embodiments of the present systems and methods, liveness detection can be performed in conjunction with biometric capture to ensure that liveness can be attributed to the individual whose iris biometrics are being captured. By closely integrating and interoperating the liveness detection and biometric capturing mechanisms within a biometric acquisition device, both functions can be performed effectively and efficiently to minimize risk from spoofing. The biometric acquisition device can use or incorporate a plurality of illuminators that interoperate with an imaging sensor, to perform liveness detection and/or biometric capturing. At least one of the illuminators may be positioned relative to the imaging sensor and/or a subject to cause a red-eye effect on a live eye. This red-eye effect can be used to confirm liveness of the eye from which iris biometrics may be acquired, while the iris biometrics can be acquired using one or more of the other illuminators to illuminate a corresponding iris.

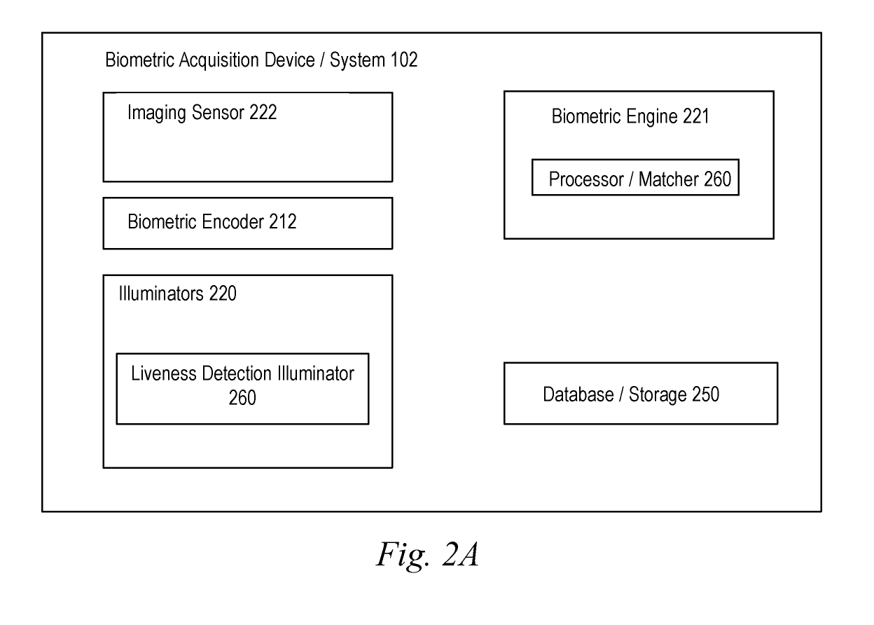

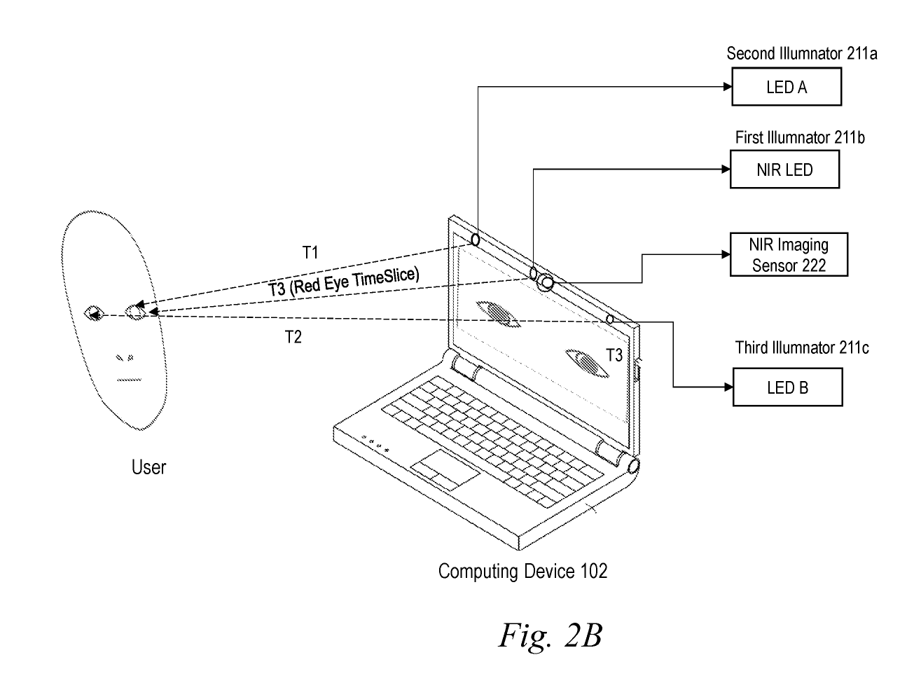

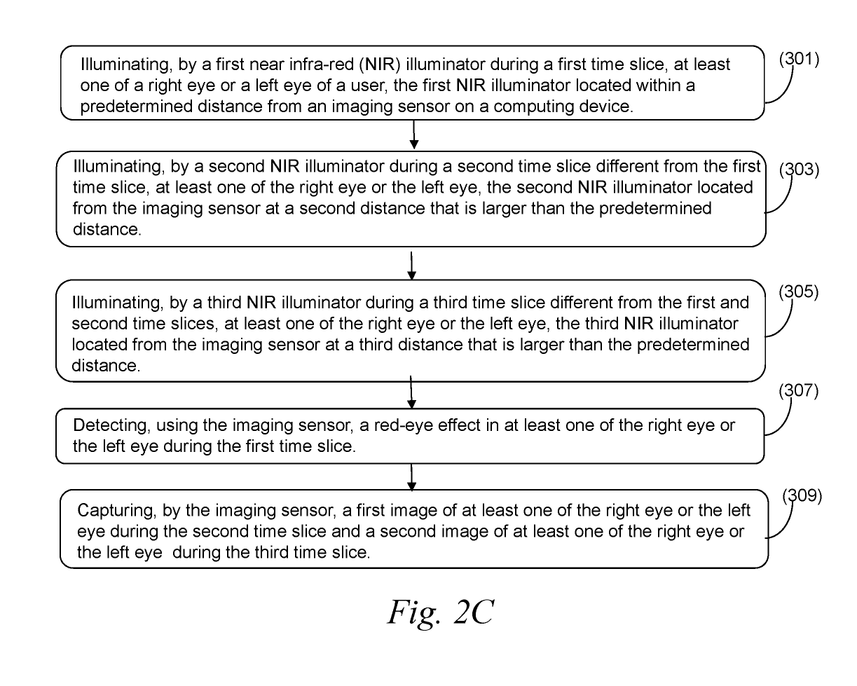

Referring to FIG. 2A, one embodiment of a system for illumination control for biometric capture and liveness detection is depicted. In brief overview, the system may include one or more subsystems or modules, for example, one or more imaging sensors 222, a biometric encoder 212, and/or a plurality of illuminators 220 for instance. The biometric acquisition device 102 may include or communicate with a database or storage device 250, and/or a biometric engine 221. For instance, the biometric acquisition device 102 may transmit a biometric template generated from an acquired iris image, to the database 250 for storage. The database 250 may incorporate one or more features of any embodiment of memory/storage elements 122, 140, as discussed above in connection with at least FIGS. 1B-1C. In some embodiments, the biometric acquisition device 102 and/or the database 250 may provide a biometric template to a biometric engine 221 for biometric matching against one or more other biometric template. In certain embodiments, the biometric acquisition device 102 may not include the database 250 and/or the biometric engine 221, but may be in communication with one or both of these.

The biometric acquisition device 102 can be a standalone device or integrated into another device. The biometric acquisition device may or may not be a mobile or portable device. The biometric acquisition device can for example correspond to, or be incorporated into a smart phone, laptop computer, tablet, desktop computer, watch or timepiece, eye wear, or camera, although not limited to these embodiments. The biometric acquisition device can include any feature or embodiment of a computing device 100 or client device 102 described above in connection with FIGS. 1A-1C for example.

Each of the elements, modules and/or submodules in the biometric acquisition device or system 102 is implemented in hardware, or a combination of hardware and software. For instance, each of these elements, modules and/or submodules can optionally or potentially include one or more applications, programs, libraries, scripts, tasks, services, processes or any type and form of executable instructions executing on hardware of the device 102 for example. The hardware may include one or more of circuitry and/or a processor, for example, as described above in connection with at least 1B and 1C. Each of the subsystems or modules may be controlled by, or incorporate a computing device, for example as described above in connection with FIGS. 1A-1C.

An imaging sensor or camera 222 may be configured to acquire iris biometrics or data, such as in the form of one or more iris images. The system may include one or more illumination sources to provide light (e.g., near infra-red or otherwise) for illuminating an iris for image acquisition. The imaging sensor 222 may comprise one or more sensor elements, and may be coupled with one or more filters (e.g., an IR-pass filter) to facilitate image acquisition. The imaging sensor 222 may be configured to focus on an iris and capture an iris image of suitable quality for performing iris recognition. The imaging sensor 222 may be configured to acquire an image of an internal reflection of illumination incident on the pupil of a live eye (sometimes generally referred to as red-eye effect). This red-eye effect may comprise a reflection of light (e.g., IR or NIR light) that is concentrated in the pupil region, and may not be red in color when imaged or detected. The imaging sensor 222 may capture the red-eye effect and iris biometrics using illumination from different illuminators 220, as described in this disclosure.

In some embodiments, an image processor of the system may operate with the imaging sensor 222 to locate and/or zoom in on an iris of an individual for image acquisition. In certain embodiments, an image processor may receive an iris image from the sensor 211, and may perform one or more processing steps on the iris image. For instance, the image processor may identify a region (e.g., an annular region) on the iris image occupied by the iris. The image processor may identify an outer edge or boundary, and/or an inner edge or boundary of the iris on the iris image, using any type of technique (e.g., edge and/or intensity detection, Hough transform, etc.). The image processor may segment the iris portion according to the inner (pupil) and outer (limbus) boundaries of the iris on an acquired image. In some embodiments, the image processor may detect and/or exclude some or all non-iris objects in an acquired image, such as eyelids, eyelashes and specular reflections that, if present, can occlude some portion of iris texture. In some embodiments, the image processor may operate to detect a pupil and/or occurrence of a red-eye effect in an acquired image. The image processor may isolate and/or extract the iris and/or pupil portion from the image for further processing. For instance, the image processor may incorporate or use an auto-focus and/or feature detection mechanism or software to help focus on a feature, detect the feature, and/or isolate the feature on an image.

The biometric acquisition device or system 102 may include one or a plurality of illuminators. For example, and in some embodiments, the biometric acquisition device may have a single illuminator that can be moved or positioned relative to a position of the imaging sensor on the device, e.g., via sliding-tracks, or use of articulated arms or support structure. In certain embodiments, the biometric acquisition device may have a plurality of illuminators, each of which may be spatially positioned at a respective fixed or static location relative to the position and/or orientation of the imaging sensor. In some embodiments, the biometric acquisition device may have a plurality of illuminators, some of which may be fixed relative to the imaging sensor, and some of which may be movable/repositioned relative to the imaging sensor.

One or more of the illuminators may have adjustable light intensities, and may operate in certain light wavelengths (e.g., IR or NIR, or in the visible spectrum). For instance, one illuminator may operate in the visible spectrum for triggering red-eye effect in acquired images. Alternatively, the illuminator may operate using IR or NIR light, for instance to avoid creating discomfort or distraction to a subject. The illuminator may operate using light of wavelength(s) selected to improve detection of the red-eye effect, for example while reducing device power. In some embodiments, the illuminator may use, provide or output IR or NIR light for instance, because the imaging sensor is configured (or operating in a mode optimized) to detect features imaged using such light. In some embodiments, the illuminator for triggering red-eye effect may be configured to use IR or NIR light for liveness detection, to operate efficiently or synergistically with biometric acquisition components of the system using IR or NIR light.

One or more of the illuminators may comprise light emitting diode (LED), incandescent, fluorescent, or high-intensity discharge (HID) type light sources, or other types of light sources. One or more of the illuminators may produce or emit collimated or non-collimated light. Some of the illuminators may operate with an intensity level, wavelength, duration, power, beam/ray direction, etc., different from some other of the illuminators. For example, an illuminator for triggering red-eye effect may operate at an intensity level higher or lower than that of an illuminator used during image acquisition. An illuminator for triggering red-eye effect may sometimes be generally referred as “red-eye illuminator” hereafter.

In some embodiments, the red-eye illuminator is positioned or located on the biometric acquisition device 102 at a predetermined distance (spatial or angular), position and/or orientation relative to the imaging sensor. The red-eye illuminator may be positioned proximate to the sensor, for example, within 1 centimeter of the sensor. In some embodiments, the red-eye illuminator may be positioned as close to the imaging sensor as is possible on the biometric acquisition device 102. The red-eye illuminator may be designed or configured to be positioned and/or oriented relative to the imaging sensor so as to trigger, enhance and/or optimize the red-eye effect on a live eye. The red-eye illuminator may be positioned within a distance (e.g., spatial or angular distance) or distance range relative to the imaging sensor, so that the red-eye effect on a live eye is triggered when the live eye is gazing at least generally in the direction of the imaging sensor, or a predetermined feature or spot on the biometric acquisition device 102 for instance. The directional axis of the red-eye illuminator may be oriented to be within a predetermined angular range as the direct light of sight of the imaging sensor. The directional axis of the red-eye illuminator may be oriented to maximize the amount of light directed into the pupil, to ensure at least a certain level of light entering the pupil and/or causing internal reflection.

The red-eye illuminator may be positioned relative to the imaging sensor so as to generate a red-eye effect in one or more eyes directed or facing at least generally in the direction of the imaging sensor. The red-eye illuminator may generate or emit a light pulse that is uniform in intensity level or otherwise, during detection of the red-eye effect. The light pulse may extend over a predetermined time slice or duration. The light pulse may occur proximate to the time instance(s) of iris data acquisition, for example, to ensure the integrity and/or validity of the liveness detection results in association with the acquired iris data. In some embodiments, the light pulse may be designed to constrict the pupil to expose a larger area of iris for subsequent biometric acquisition.

The red-eye illuminator may provide illumination during a time slice relative to one or other time slices during which image acquisitions occur. One or more of the other illuminators may operate during one or more other time slices, to illuminate a subject for the purpose of iris image acquisition, rather than to trigger a red-eye effect. The one or more of the other illuminators may illuminate one or more eyes during image acquisition. In some embodiments, a first illuminator may illuminate one or both eyes during a first time slice, and a second illuminator may illuminate one or both eyes during a second time slice, for separate acquisition of iris data. The first and second illuminators may operate at the same light wavelength for example, and may operate at the same or similar intensity levels.

The first and second illuminators may be located and/or oriented at different locations relative to the imaging sensor. The positions and/or orientations of the first and second illuminators may be configured or designed to provide illumination diversity such that reflections (e.g., off eye wear), obstructions (e.g., from eye lashes, eye wear) and/or specularities affecting or obscuring iris data collected in one image may possibly be avoided in another acquired image illuminated differently. As such, multiple biometric images may be acquired each using light from a different illuminator, and one or more suitable image(s) may be selected for further processing, storage or use.

The illuminators for biometric acquisition may located and/or oriented to illuminate a subject for the purpose of iris image acquisition, rather than to trigger a red-eye effect. For instance, each of these illuminators may be located and/or oriented at a distance (e.g., spatial or angular) or within a distance range relative to the imaging sensor, so as to avoid triggering a red-eye effect. The combination of types of illuminators on a biometric acquisition device may be configured, in location and/or orientation for example, according to the size and/or shape of the biometric acquisition device. The combination of types of illuminators on a biometric acquisition device may be configured on each biometric acquisition device to meet predetermined requirements for liveness detection and/or iris biometric acquisition, or to optimize for liveness detection and/or iris biometric acquisition.

In some embodiments, the red-eye illuminators, and one or more illuminators for biometric acquisition, operate during time slices that all occur within a predetermined time period, so as to associate the respective results with one another. These illuminators may operate to provide light at IR or NIR wavelengths, so that a subject is not aware of, or does not detect the light (e.g., is not bothered or distracted by the light) and/or the associated liveness detection and biometric acquisition. By performing an integrated liveness detection and biometrics acquisition process, security risks arising from spoofing may be eliminated or reduced. FIG. 2B depicts an example embodiment of a system for illumination control for liveness detection and biometric acquisition. An example of how the illuminators may be installed relative to the imaging sensor 222 on a laptop type device, and operated during different time slices (T1, T2, T3), is shown

In some embodiments, the biometric acquisition device or system 102 includes a database 250. The database may include or store biometric information, e.g., acquired by the imaging sensor 222, and/or enrolled via the biometric encoder 222 and/or another device. The database may include or store information pertaining to a user, such as that of a transaction (e.g., liveness detection result, date, time, value of transaction, type of transaction), an identifier (e.g., name, account number, contact information), a location (e.g., geographical locations, IP addresses).

Referring now to FIG. 2C, one embodiment of a method using iris data for authentication is depicted. The method may include illuminating, by a first NIR illuminator during a first time slice, at least one of a right eye or a left eye of a user (301). The first NIR illuminator may be located within a predetermined distance from an imaging sensor on a computing device. A second NIR illuminator may illuminate, during a second time slice different from the first time slice, at least one of the right eye or the left eye (303). The second NIR illuminator may be located from the imaging sensor at a second distance that is larger than the predetermined distance. A third NIR illuminator may illuminate, during a third time slice different from the first and second time slices, at least one of the right eye or the left eye (305). The third NIR illuminator may be located from the imaging sensor at a third distance that is larger than the predetermined distance. The imaging sensor may be used to detect a red-eye effect in at least one of the right eye or the left eye during the first time slice (307). The imaging sensor may capture a first image of at least one of the right eye or the left eye during the second time slice and a second image of at least one of the right eye or the left eye during the third time slice (309).

Referring now to (301), and in some embodiments, a first NIR illuminator may illuminate, during a first time slice, at least one of a right eye or a left eye of a user. The computing device may include a plurality of illuminators, including first, second and third NIR illuminators. In certain embodiments, the illuminators may each be spatially positioned at a respective fixed or static location relative to the position and/or orientation of the imaging sensor. The first NIR illuminator may be located within a predetermined distance from an imaging sensor on the computing device. The predetermined distance may comprise a spatial distance or angular distance within which a NIR light source causes red-eye effect, and beyond which the NIR light source does not cause red-eye effect. The red-eye effect may comprise an internal reflection of light entering a pupil.

The first NIR illuminator may be positioned proximate to the sensor, for example, within 1 centimeter of the sensor. In some embodiments, the first NIR illuminator may be positioned as close to the imaging sensor as is possible on the biometric acquisition device 102. The first NIR illuminator may be designed or configured to be positioned and/or oriented relative to the imaging sensor so as to trigger, enhance and/or optimize the red-eye effect on a live eye. The first NIR illuminator may be positioned within a distance (e.g., spatial or angular distance) or distance range relative to the imaging sensor, so that the red-eye effect on a live eye is triggered when the live eye is gazing at least generally in the direction of the imaging sensor, or a predetermined feature or spot on the biometric acquisition device 102 for instance. The directional axis of the first NIR illuminator may be oriented to be within a predetermined angular range as the direct light of sight of the imaging sensor. The directional axis of the first NIR illuminator may be oriented to maximize the amount of light directed into the pupil, to ensure at least a certain level of light entering the pupil and/or causing internal reflection.

The first NIR illuminator may be positioned relative to the imaging sensor so as to generate a red-eye effect in one or more eyes directed or facing at least generally in the direction of the imaging sensor. The first NIR illuminator may generate or emit a light pulse that is uniform in intensity level or otherwise, during detection of the red-eye effect. The light pulse may extend over a predetermined time slice or duration. The light pulse may occur proximate to the time instance(s) of iris data acquisition, for example, to ensure the integrity and/or validity of the liveness detection results in association with the acquired iris data. In some embodiments, the light pulse may be designed to constrict the pupil to expose a larger area of iris for subsequent biometric acquisition. The red-eye illuminator may provide illumination during a time slice relative to one or other time slices during which image acquisitions occur. One or more of the other illuminators may operate during one or more other time slices, to illuminate a subject for the purpose of iris image acquisition, rather than to trigger a red-eye effect.

Referring to (303) and in some embodiments, a second NIR illuminator may illuminate, during a second time slice different from the first time slice, at least one of the right eye or the left eye. The second NIR illuminator may be located from the imaging sensor at a second distance that is larger than the predetermined distance. The second and third NIR illuminators may located and/or oriented to illuminate a subject for the purpose of iris image acquisition, rather than to trigger a red-eye effect. For instance, each of these illuminators may be located and/or oriented at a distance (e.g., spatial or angular) or within a distance range relative to the imaging sensor, so as to avoid triggering a red-eye effect.

Referring to (305) and in some embodiments, a third NIR illuminator may illuminate, during a third time slice different from the first and second time slices, at least one of the right eye or the left eye. In some embodiments, the first, second and third time slices all occur within a predetermined time period. The first, second and third time slices all occur within a time period of 25 milliseconds (or 1, 10, 20, 50, 100, 200, 500 milliseconds, as examples). In some embodiments, the NIR illuminators operate during time slices that all occur within a predetermined time period, so as to associate the respective results with one another.

The third NIR and second NIR illuminators may operate at the same light wavelength for example, and may operate at the same or similar intensity levels. In some embodiments, the first NIR illuminator may illuminate at least one of the right eye or the left eye at a first illumination level that is different from that of the second and third NIR illuminators during the second and third time slices. For example, first NIR illuminator may operate at an intensity level higher or lower than that of an illuminator used during image acquisition. The first time slice may extend over a duration that is different from that of the second and third time slices. The first, second or third time slice may or may not overlap in part with another time slice.

The second and third NIR illuminators may be located and/or oriented at different locations relative to the imaging sensor. In certain embodiments, the third NIR illuminator may be located from the imaging sensor at a third distance that is larger than the predetermined distance. The predetermined distance, the second distance and the third distance from the imaging sensor may comprise a predetermined angular distance, a second angular distance and a third angular distance respectively, between a respective illuminator's illumination axis and an imaging axis of the imaging sensor. The positions and/or orientations of the second and third NIR illuminators may be configured or designed to provide illumination diversity such that reflections (e.g., off eye wear), obstructions (e.g., from eye lashes, eye wear) and/or specularities affecting or obscuring iris data collected in one image may possibly be avoided in another acquired image illuminated differently. As such, multiple biometric images may be acquired each using light from a different illuminator, and one or more suitable image(s) may be selected for further processing, storage or use. Each of the positions and/or orientations of the NIR illuminators may be configured or optimized according to the working or expected distances of the subject from the illuminators and/or imaging sensor.

Referring to (307) and in some embodiments, the imaging sensor may be used to detect a red-eye effect in at least one of the right eye or the left eye during the first time slice. The imaging sensor 222 may be configured to acquire an image of an internal reflection of illumination incident on the pupil of a live eye, back to the imaging sensor (giving the impression of a much more illuminated pupil that normal). Such an internal reflection is caused by a live iris and cannot be easily replicated by fake techniques. The image processor may operate to detect a pupil and/or occurrence of a red-eye effect in an acquired image. A processor of the computing device may execute a program or algorithm to process or analyze an image of the right eye and/or left eye acquired by the imaging sensor, to detect or identify the red-eye effect.

Referring to (309) and in some embodiments, the imaging sensor may capture a first image of at least one of the right eye or the left eye during the second time slice and a second image of at least one of the right eye or the left eye during the third time slice. This time slicing may be done to ensure a seamless recognition operation between red-eye detection and iris data capture, so that red-eye effect does not corrupt collected iris data for instance. The imaging sensor may capture, responsive to the detection of the red-eye effect using the imaging sensor, the first image during the second time slice and the second image during the third time slice. The computing device may store or use at least one of the first image or the second image for biometric matching, responsive to detecting the red-eye effect.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method for iris illumination, the method comprising:
illuminating, by a first near infra-red (NIR) illuminator during a first time slice, at least one of a right eye or a left eye of a user, the first NIR illuminator located within a predetermined distance from an imaging sensor on a computing device;
illuminating, by a second NIR illuminator during a second time slice different from the first time slice, at least one of the right eye or the left eye, the second NIR illuminator located from the imaging sensor at a second distance that is larger than the predetermined distance;
illuminating, by a third NIR illuminator during a third time slice different from the first and second time slices, at least one of the right eye or the left eye, the third NIR illuminator located from the imaging sensor at a third distance that is larger than the predetermined distance;
detecting, using the imaging sensor, a red-eye effect in at least one of the right eye or the left eye during the first time slice; and
capturing, by the imaging sensor, a first image of at least one of the right eye or the left eye during the second time slice and a second image of at least one of the right eye or the left eye during the third time slice.

2. The method of claim 1, comprising capturing, responsive to the detection of the red-eye effect using the imaging sensor, the first image during the second time slice and the second image during the third time slice.

3. The method of claim 1, comprising illuminating, by the first NIR illuminator, at least one of the right eye or the left eye at a first illumination level that is different from that of the second and third NIR illuminators during the second and third time slices.

4. The method of claim 1, wherein the first time slice extends over a duration that is different from that of the second and third time slices.

5. The method of claim 1, wherein the predetermined distance, the second distance and the third distance from the imaging sensor comprise a predetermined angular distance, a second angular distance and a third angular distance respectively, between a respective illuminator's illumination axis and an imaging axis of the imaging sensor.

6. The method of claim 1, wherein the predetermined distance comprises a spatial distance or angular distance within which a NIR light source causes red-eye effect, and beyond which the NIR light source does not cause red-eye effect.

7. The method of claim 1, wherein the first, second and third time slices all occur within a predetermined time period.

8. The method of claim 1, wherein the first, second and third time slices all occur within a time period of 25 milliseconds.

9. The method of claim 1, wherein the red-eye effect comprises an internal reflection of light entering a pupil.

10. The method of claim 1, further comprising storing or using at least one of the first image or the second image for biometric matching, responsive to detecting the red-eye effect.

11. A system for iris illumination, the system comprising:
an imaging sensor;
a first near infra-red (NIR) illuminator configured to illuminate at least one of a right eye or a left eye of a user during a first time slice, the first NIR illuminator located within a predetermined distance from an imaging sensor on a computing device;
a second NIR illuminator configured to illuminate at least one of the right eye or the left eye during a second time slice different from the first time slice, the second NIR illuminator located from the imaging sensor at a second distance that is larger than the predetermined distance; and
a third NIR illuminator configured to illuminate at least one of the right eye or the left eye during a third time slice different from the first and second time slices, the third NIR illuminator located from the imaging sensor at a third distance that is larger than the predetermined distance;
wherein the imaging sensor is used to detect a red-eye effect in at least one of the right eye or the left eye during the first time slice, and the imaging sensor is configured to capture a first image of at least one of the right eye or the left eye during the second time slice and a second image of at least one of the right eye or the left eye during the third time slice.

12. The system of claim 11, wherein the imaging sensor is configured to capture, responsive to the detection of the red-eye effect, the first image during the second time slice and the second image during the third time slice.

13. The system of claim 11, wherein the first NIR illuminator is configured to illuminate at least one of the right eye or the left eye at a first illumination level that is different from that of the second and third NIR illuminators during the second and third time slices.

14. The system of claim 11, wherein the first time slice extends over a duration that is different from that of the second and third time slices.

15. The system of claim 11, wherein the predetermined distance, the second distance and the third distance from the imaging sensor comprise a predetermined angular distance, a second angular distance and a third angular distance respectively, between a respective illuminator's illumination axis and an imaging axis of the imaging sensor.

16. The system of claim 11, wherein the predetermined distance comprises a spatial distance or angular distance within which a NIR light source causes red-eye effect, and beyond which the NIR light source does not cause red-eye effect.

17. The system of claim 11, wherein the first, second and third time slices all occur within a predetermined time period.

18. The system of claim 11, wherein the first, second and third time slices all occur within a time period of 25 milliseconds.

19. The system of claim 11, wherein the red-eye effect comprises an internal reflection of light entering a pupil.

20. The system of claim 11, further comprising a processor configured to store or use at least one of the first image or the second image for biometric matching, responsive to detecting the red-eye effect.
